(19) United States
(12) Patent Application Publication
(10) Pub. No.: US 2016/0157472 A1
(43) Pub. Date: Jun. 9, 2016

(54) FISHING LURE

(71) Applicant: Andrew John NEAL, Quinns Rocks (AU)

(72) Inventor: Andrew John Neal, Quinns Rocks (AU)

(21) Appl. No.: 14/905,286

(22) PCT Filed: Jul. 18, 2014
(86) PCT No.: PCT/AU2014/000736

§ 371 Date: Jan. 14, 2016

(30) Foreign Application Priority Data
Jul. 18, 2013 (AU) 2013902670

(51) Int. Cl. A01K 85/18

(52) U.S. Cl. CPC A01K 85/18

(57) ABSTRACT

A fishing lure (10) comprising a flexible frame (12) formed from first and second side walls (18, 20) defining a tubular member (14). One or more hook connections (32) are provided on the frame for receiving fishing hooks (34). The first and second side walls (18, 20) may be flexed apart to receive a bait fish (11) and will flex back to secure the bait fish (11) within the tubular member (14).

### FIELD OF THE INVENTION

The present invention relates to fishing lure.

### BACKGROUND TO THE INVENTION

Small fish are commonly used as bait when fishing. Such bait fish are generally simply threaded onto one or more hooks attached to the end of the fishing line. One issue with this method is that the relatively soft nature of the bait fish can lead to the fish being pulled from the hooks by a fish, or simply falling off.

The present invention relates to a fishing lure having the capacity to hold bait. The fishing lure of the present invention includes features aimed at making the device easy to use and effective in securely holding the bait while fishing.

### SUMMARY OF THE INVENTION

According to one aspect of the present invention there is provided a fishing lure comprising:
a resilient flexible frame formed from first and second side walls defining a tubular member; and
one or more hook connections provided on the frame for receiving fishing hooks;
   wherein the first and second side walls may be flexed apart to receive a bait fish and will flex back to secure the bait fish within the tubular member.

Preferably the frame includes a spine comprising an elongate member oriented lowermost in use, the first and second side walls extending outwardly from opposed sides of the spine.

Preferably first and second side walls each have a lower edge joined to the spine and a remote upper edge, the upper edges being located adjacent each other and parallel to define an elongate gap.

In a preferred embodiment, the gap includes a widened portion adjacent a first end of the frame.

In a preferred embodiment, the frame includes a nose portion connecting between the first and second side walls adjacent a first end of the frame and wherein the first and second side walls define an opening adjacent the second end of the frame such that the tubular member includes a closed first end and an open second end.

In one embodiment, the nose portion is generally conical in shape.

Preferably the spine and the first and second side walls are integrally formed of a flexible, resilient material.

In a preferred embodiment, the first and second side walls taper down in size adjacent the first and second ends thereof such that an elongate chamber defined by the tubular member is larger in cross sectional area adjacent a midpoint thereof than adjacent the adjacent the first and second ends.

Preferably the first and second side walls are formed of a mesh structure.

In one embodiment, the hook connections comprise ring members secured to the frame. In one embodiment the hook connections are provided on the spine.

Preferably a front connection point is, provided adjacent the first end of the frame for connection to a fishing line. In one embodiment, the front connection point comprises a ring connected to the nose portion of the frame.

Preferably a dive lip is provided adjacent the first end of the spine to control movement of the fishing lure through the water.

In a preferred embodiment, side slots are provided for receiving a body portion of further hooks.

Preferably the slots are provided on each of the side walls, extending from adjacent the first end of the frame to a location between the first end and the second end of the frame generally between the lower edge and the upper edge of the each of the side walls.

Preferably inner surfaces of the side walls include protrusions provide to engage with and hold the bait fish in place.

In one embodiment, the protrusions include a plurality of ribs provided at locations along the length of each of the side walls, the ribs extending perpendicular to the longitudinal axis of the frame.

In one embodiment, the protrusions include one or more spikes provided along the length of the inner surfaces of the side walls.

### BRIEF DESCRIPTION OF THE DRAWINGS

The invention will now be described, by way of example, with reference to the following drawings, in which:

FIG. 1 is a front upper perspective view of a fishing accordance with the present invention;

FIG. 2 is a rear upper perspective view of the fishing lure of FIG. 1;

FIG. 3 is a side view of the fishing lure of FIG. 1;

FIG. 4 is a lower perspective view of the fishing lure of FIG. 1;

FIG. 5a is a top view of the fishing lure of FIG. 1;

FIG. 5b is a bottom view of the fishing lure of FIG. 1;

FIG. 6 is a rear view of the fishing lure of FIG. 1;

FIG. 7 is a side cross sectional view of a rear portion of the fishing lure of FIG. 1;

FIG. 8a is a side cross sectional view of a hook partially received in a slot of the fishing lure;

FIG. 8b is a side cross sectional view of the hook fully received in the slot of the fishing lure;

FIG. 8c is an end cross sectional view of the hook fully received in the slot of the fishing lure;

FIG. 8d is a top view of the hook received in the slot;

FIG. 9 is a side view of a front portion of the fishing lure of FIG. 1 showing attachment of the hook into the slot;

FIG. 10 is a front upper perspective view of the fishing lure of FIG. 1 shown holding a bait fish; and

FIG. 11 is a rear upper perspective view of the fishing lure of FIG. 1 shown holding the bait fish.

### DETAILED DESCRIPTION OF PREFERRED EMBODIMENTS

Referring to the Figures, there is shown a fishing lure 10 comprising a flexible frame 12. The flexible frame 12 comprises a tubular member 14 having a first end 21 and a second end 22, defining an elongate chamber therein.

The frame 12 is formed from a spine 16, a first side wall 18 and a second side wall 20. The spine 16 comprises an elongate member extending from the first end 21 to the second end 22 of the frame 12 and is oriented lowermost in use. The first side wall 18 extends outwardly from a first side of the spine 16 and the second side wall 20 extends outwardly from a second opposite side of the spine 16.

The first and second side walls 18 and 20 comprise walls each having a lower edge 23 joined to the spine 16 and a remote upper edge 24. The upper edge 24 of the first side wall 18 is located adjacent the upper edge 24 of the second side wall 20 such that the first and second walls 18 and 20 define the tubular member 14.

The frame 12 of the fishing lure 10 includes a nose portion 26 connecting between the first and second side walls 18 and 20 adjacent the first end 21 of the frame 12 thereof. The nose portion 26 is generally conical in shape and closes off the first end 21 of the tubular member 14. The first and second side walls 18 and 20 of the frame 12 define a generally elliptical opening 28 adjacent the second end 22 of the frame 12. The tubular member 14 therefore includes a closed first end 21 and an open second end 22.

The first and second side walls 18 and 20 taper down in size adjacent the first and second ends 21 and 22 thereof such that the elongate chamber is larger in cross sectional area adjacent a midpoint thereof than adjacent the first and second ends 21 and 22. The shape of the elongate chamber 15 thereby more closely corresponds with the body shape of a bait fish 11 placed within the elongate chamber.

The upper edges 24 of the first and second side walls 18 and 20 are located adjacent each other and parallel. The upper edges 24 thereby define an elongate gap 25. The gap 25 includes a widened portion 30 adjacent the first end 21 of the frame 12. That is, the widened portion 30 is located adjacent the nose portion 26 of the frame 12.

The spine 16 and the first and second side walls 18 and 20 are preferably integrally formed of a flexible, resilient material. The spine 16 and first and second side walls 18 and 20 may be formed of a flexible plastic material. The flexible nature of the first and second side walls 18 and 20 allows the side walls 18 and 20 to be flexed from a closed configuration (as shown in the drawings) to an open configuration. The side walls 18 and 20 are flexed to the open configuration by flexing apart the upper edges 24 of the side walls 18 and 20 to widen the gap 25. The resilient nature of the side walls 18 and 20 means that the side walls 18 and 20 will return to the closed position on release. The widened portion 30 of the gap 25 is provided to receive a finger which may be used to flex apart the side walls 18 and 20. The side walls 18 and 20 may also be flexed apart by inserting a finger into the opening 28 at the second end 22 of the frame 12. A bait fish 11 may be received into the frame 12 in the open configuration and will be secured when the side walls 18 and 20 return to the closed configuration.

The first and second side walls 18 and 20 are formed of a mesh structure. The first and second side walls 18 and 20 therefore include a plurality of holes along the length thereof to allow water to contact the bait fish 11 placed within the frame 12 in use.

The fishing lure 10 is provided also with hook connections 32 to which fishing hooks 34 may be secured. In the embodiment shown, hook connections 32 comprises ring members and are provided on the spine 16. A pair of hook connections 32 are provided on the spine 16 for receiving treble hooks 34a.

The fishing lure 10 is also provided with a front connection point 40 adjacent the first end 20 of the frame 12 for connection to a fishing line. The front connection point 40 comprises a ring connected to the nose portion 26 of the frame 12. The front connection point 40 may be connected to a trace 42 of a fishing line.

The fishing lure 10 is provided also with a dive lip 44 adjacent the first end 21 of the spine 16 to control movement of the fishing lure 10 through the water. The dive lip 44 extends outwardly from the nose portion 26 of the frame 12 and is dimensioned to control the desired dive depth of the fishing lure 10 in use.

Further, the fishing lure 10 is provided with side slots 36 for receiving further hooks 34. The slots 36 are provided on each of the side walls 18 and 20 extending from adjacent the first end 21 of the frame 12 to a location between the first end 21 and the second end 22 of the frame 12. The slots 36 are located generally between the lower edge 23 and the upper edge 24 of the each of the side walls 18 and 20 and extend parallel to a longitudinal axis of the frame 12.

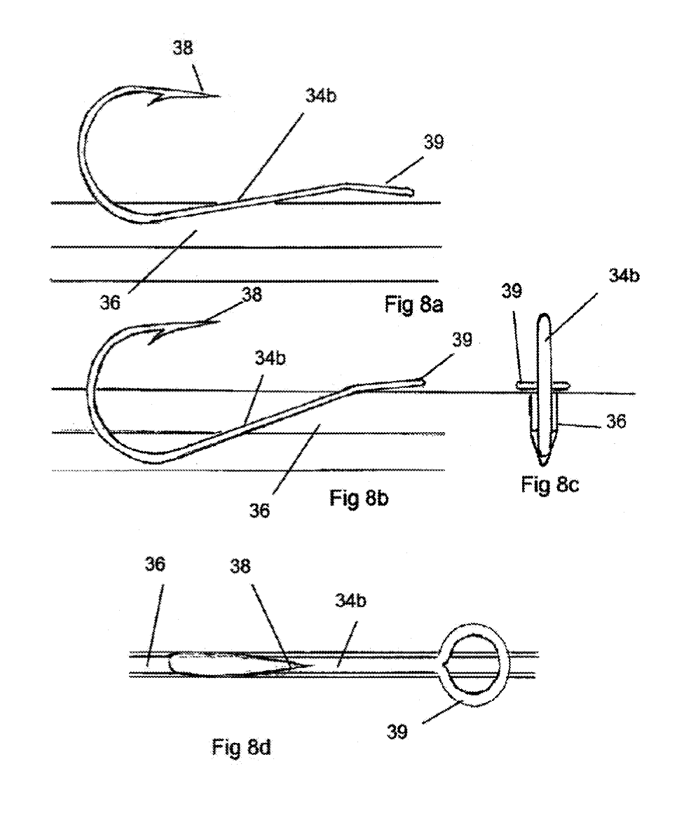

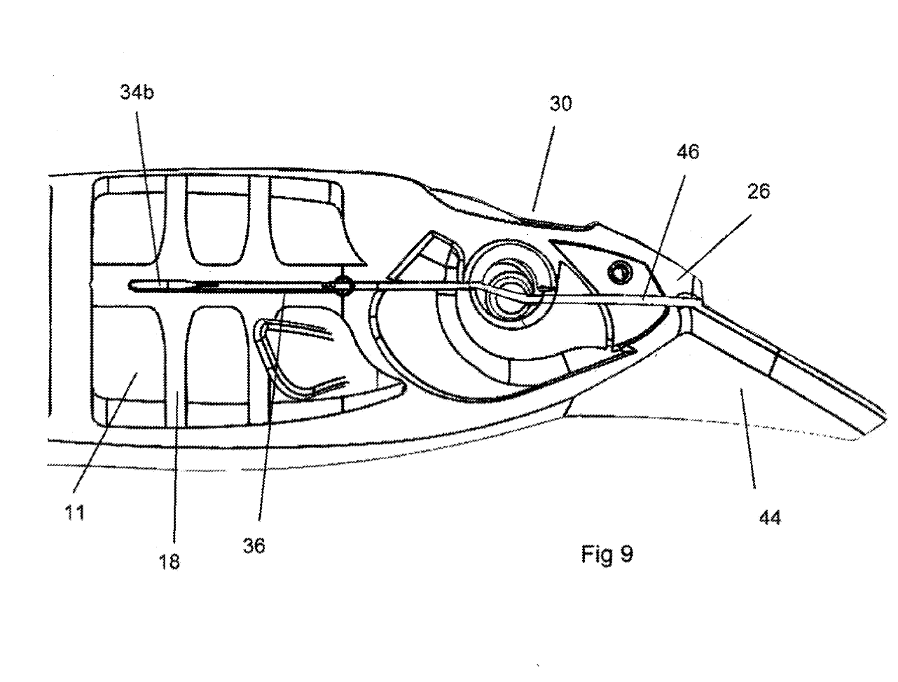

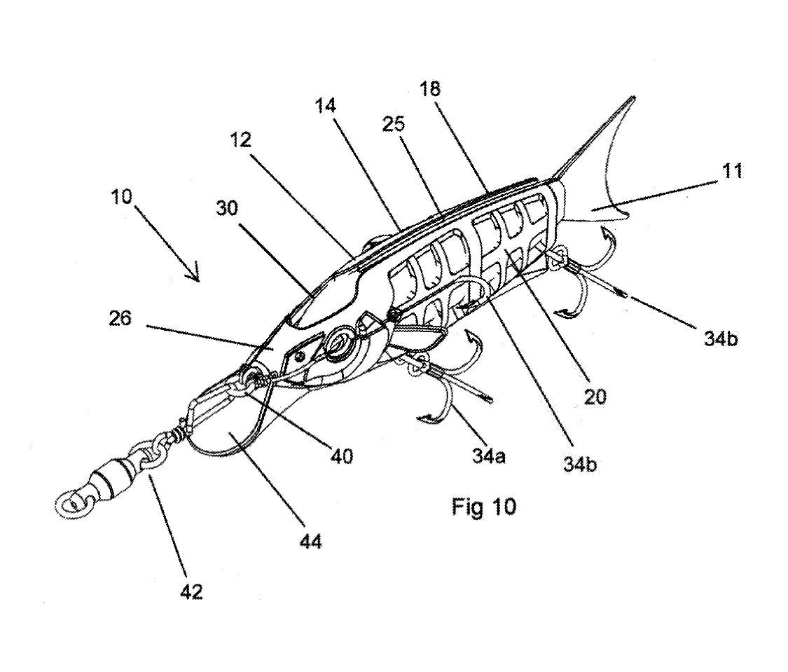

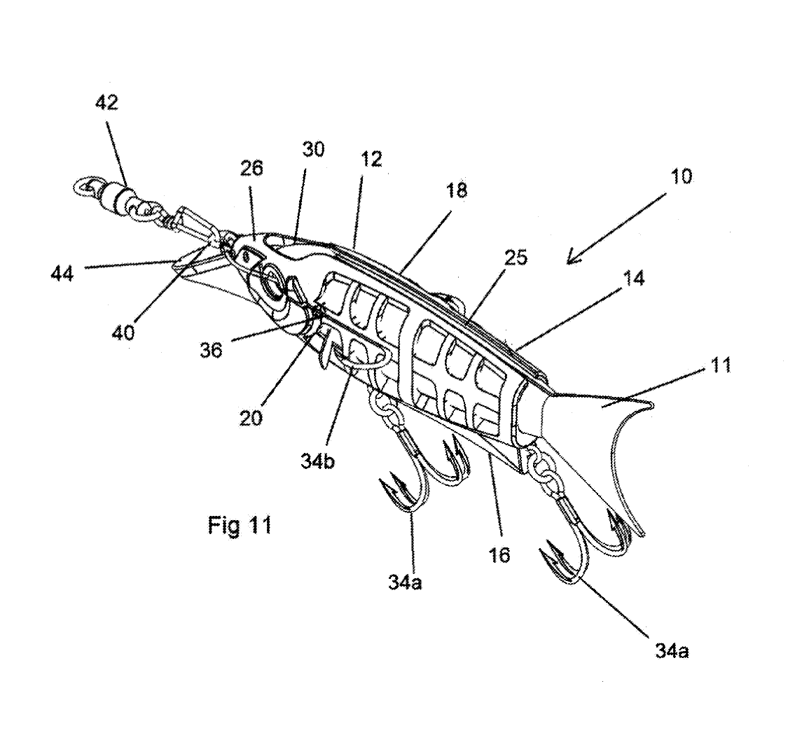

The slots 36 are provided for receiving standard hooks 34b, such as the type commonly sold as ‘assassin’ hooks. FIG. 8 shows how the body of the hook 34 is pressed into the slot 36 with the barbed end 38 and hook ring 39 located on an outer side of the side wall 18 or 20. The hooks 34b are connectable to the connection point 40 via hook line 46 tied to both the connection point 40 and the hook ring 39.

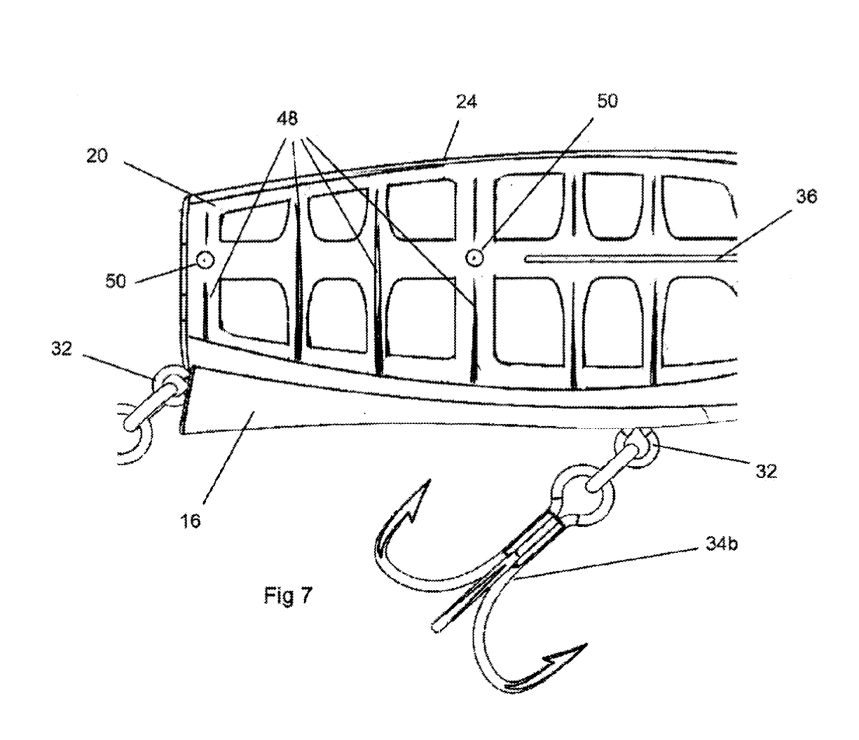

Inner surfaces of the side was 18 and 20 include protrusions provide to engage with and hold the bait fish 11 in place. The protrusions in the embodiment shown comprise a plurality of ribs 48 (as can be seen in FIG. 7). The ribs 48 are provided at a plurality of locations along the length of each of the side walls 18 and 20. The ribs 48 extend perpendicular to the longitudinal axis of the frame 12. Also provided are a plurality of spikes 50. The spikes 50 are provided at a plurality of locations along the length of the side walls 18 and 20. In the embodiment shown, the spikes 50 are located generally between the lower edges 23 and upper edges 24 of the side walls 18 and 20.

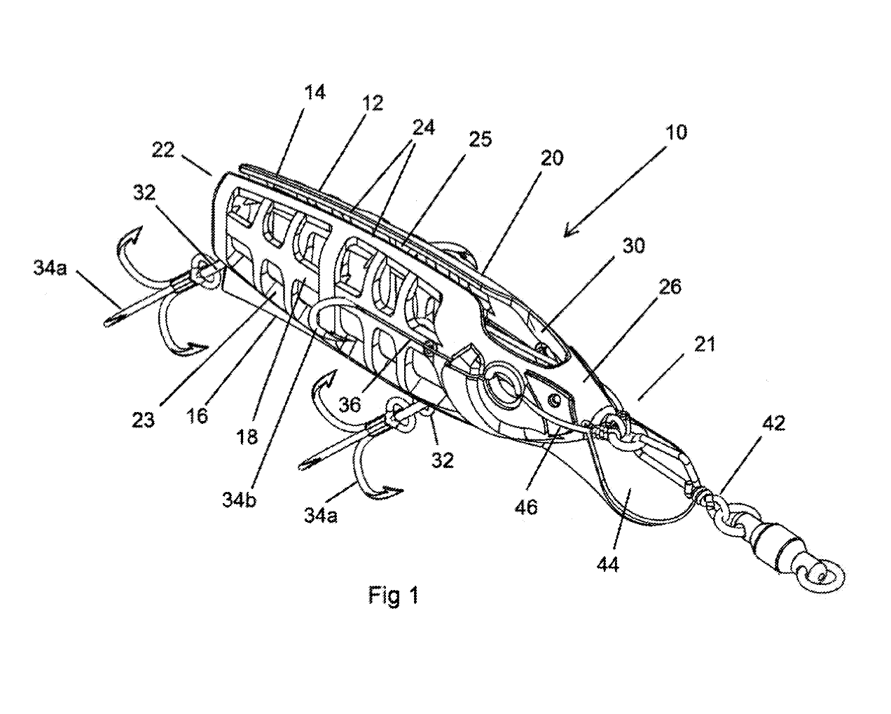

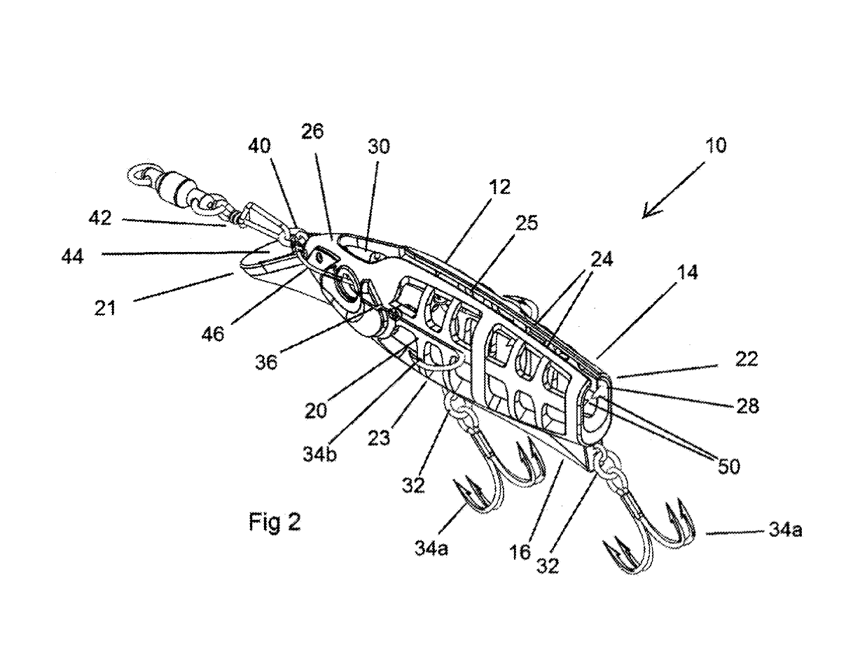

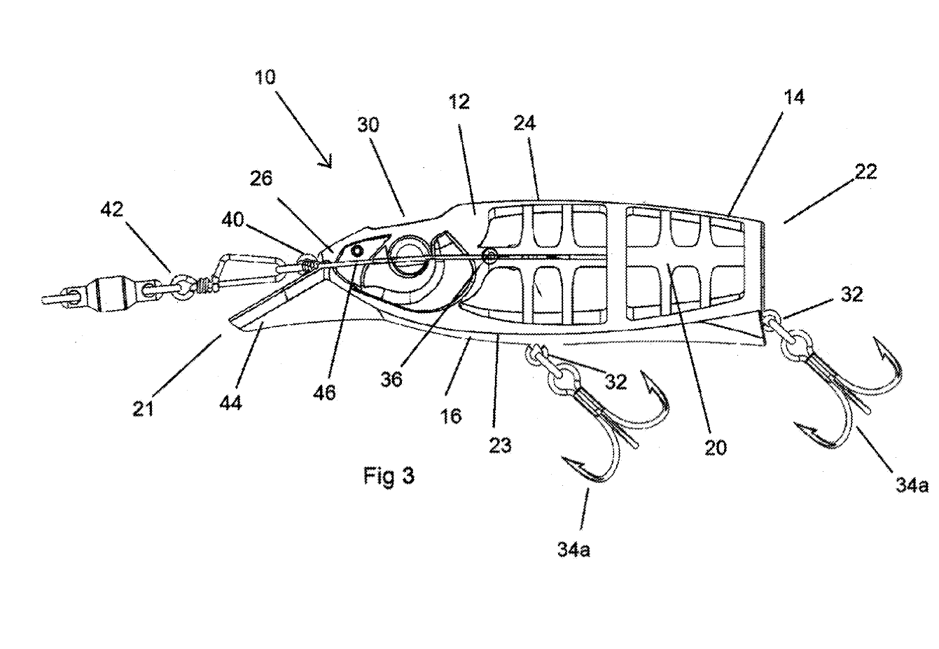

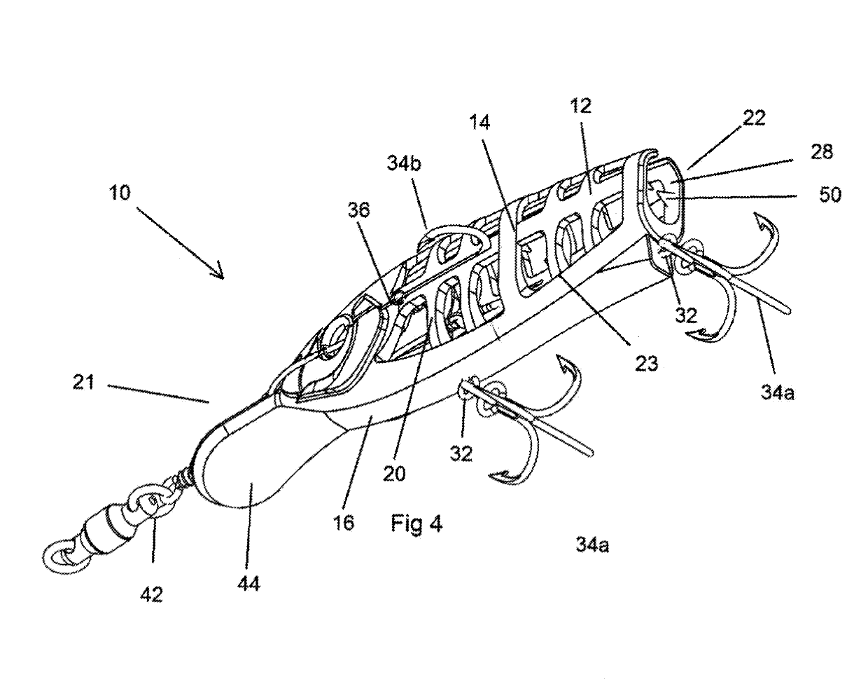

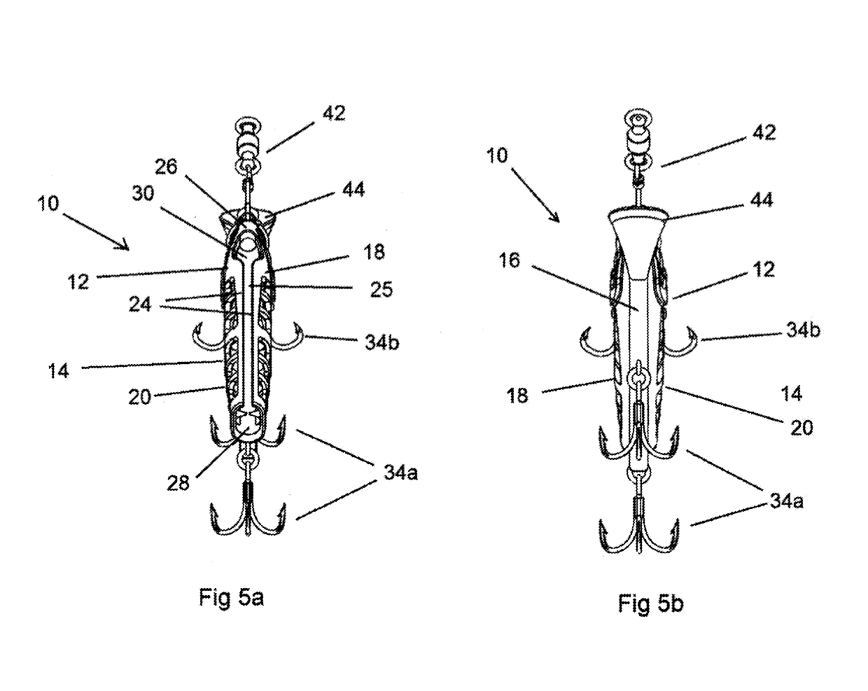

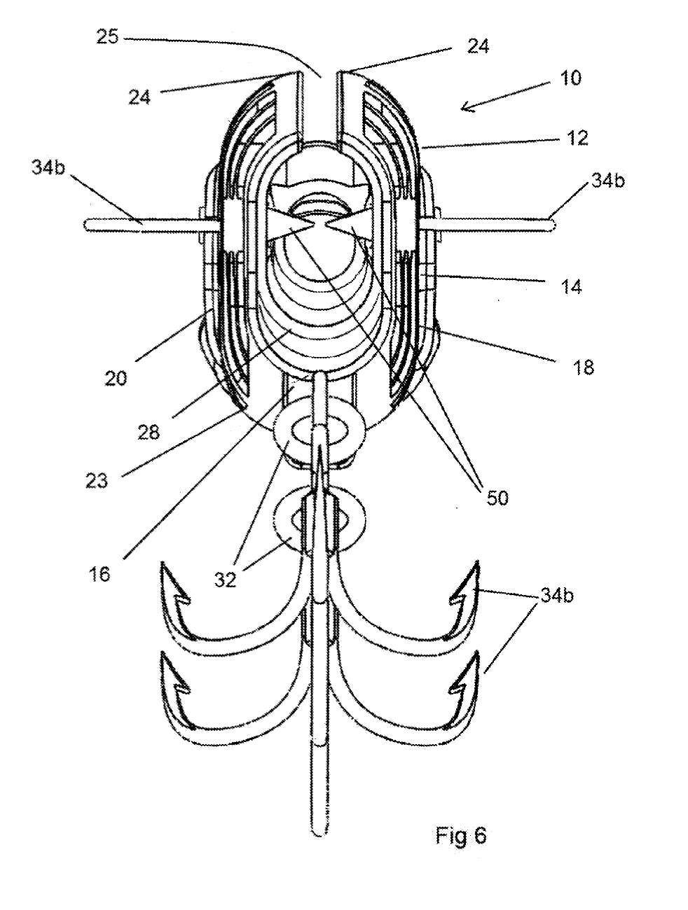

In use, the fishing lure 10 flexed to the open configuration, as shown in FIG. 1a and a bait fish 11 is placed in the frame 12. The head of the bait fish 11 is placed adjacent the first end 21 of the frame 12 and the tail of the bait fish 11 hangs out through the opening 28 in the second end 22 of the frame 12. The bait fish 11 is positioned such that the lower side of the bait fish 11 is adjacent the spine 16. The fishing lure 10 thereby retains the bait fish 11 within the frame 12 to prevent loss of the bait fish 11 during fishing. Should the bait fish 11 eventually become dislodged, the frame 12 can simply be opened to receive another bait fish 11.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A fishing lure comprising:
a resilient flexible frame formed from first and second side walls defining a tubular member; and
one or more hook connections provided on the frame for receiving fishing hooks;
wherein the first and second side walls may be flexed apart to receive a bait fish and will flex back to secure the bait fish within the tubular member.

21. A fishing lure in accordance with claim 20, wherein the frame includes a spine comprising an elongate member oriented lowermost in use, the first and second side walls extending outwardly from opposed sides of the spine.

22. A fishing lure in accordance with claim 21, wherein first and second side walls each have a lower edge joined to the spine and a remote upper edge, the upper edges being located adjacent each other and parallel to define an elongate gap.

23. A fishing lure in accordance with claim 22, wherein the gap includes a widened portion adjacent a first end of the frame.

24. A fishing lure in accordance with claim 23, wherein the frame includes a nose portion connecting between the first and second side walls adjacent a first end of the frame and wherein the first and second side walls define an opening adjacent the second end of the frame such that the tubular member includes a closed first end and an open second end.

25. A fishing lure in accordance with claim 24, wherein the nose portion is generally conical in shape.

26. A fishing lure in accordance with claim 25, wherein the spine and the first and second side walls are integrally formed of a flexible, resilient material.

27. A fishing lure in accordance with claim 26, wherein the first and second side walls taper down in size adjacent the first and second ends thereof such that an elongate chamber defined by the tubular member is larger in cross sectional area adjacent a midpoint thereof than adjacent the adjacent the first and second ends.

28. A fishing lure in accordance with claim 27, wherein, the first and second side walls are formed of a mesh structure.

29. A fishing lure in accordance with claim 28, wherein the hook connections comprise ring members secured to the frame.

30. A fishing lure in accordance with claim 29, wherein the hook connections are provided on the spine.

31. A fishing lure in accordance with claim 30, wherein a front connection point is provided adjacent the first end of the frame for connection to a fishing line.

32. A fishing lure in accordance with claim 31, wherein the front connection point comprises a ring connected to the nose portion of the frame.

33. A fishing lure in accordance with claim 32, wherein a dive lip is provided adjacent the first end of the spine to control movement of the fishing lure through the water.

34. A fishing lure in accordance with claim 33, wherein side slots are provided for receiving a body portion of further hooks.

35. A fishing lure in accordance with claim 34, wherein the slots are provided on each of the side walls, extending from adjacent the first end of the frame to a location between the first end and the second end of the frame generally between the lower edge and the upper edge of the each of the side walls.

36. A fishing lure in accordance with claim 35, wherein inner surfaces of the side walls include protrusions provide to engage with and hold the bait fish in place.

37. A fishing lure in accordance with claim 36, wherein the protrusions include a plurality of ribs provided at locations along the length of each of the side walls, the ribs extending perpendicular to the longitudinal axis of the frame.

38. A fishing lure in accordance with claim 37, wherein the protrusions include one or more spikes provided along the length of the inner surfaces of the side walls.

39. A fishing lure in accordance with claim 20, wherein inner surfaces of the side walls include protrusions provide to engage with and hold the bait fish in place.
